(19) United States
(12) Patent Application Publication
(10) Pub. No.: US 2023/0048367 A1
(43) Pub. Date: Feb. 16, 2023

(54) VOLUME BRAGG GRATING, FABRICATION METHOD AND SYSTEM

(71) Applicant: Facebook Technologies, LLC, Menlo Park, CA (US)

(72) Inventors: Jian Xu, Redmond, WA (US); Wen Xiong, Redmond, WA (US); Yang Yang, Redmond, WA (US); Wanli Chi, Sammamish, WA (US)

(73) Assignee: Facebook Technologies, LLC, Menlo, CA (US)

(21) Appl. No.: 17/877,263

(22) Filed: Jul. 29, 2022

Related U.S. Application Data
(60) Provisional application No. 63/228,587, filed on Aug. 2, 2021.

(51) Int. Cl. G03H 1/22; G02B 5/32

(52) U.S. Cl. CPC G03H 1/2294; G03H 1/2205; G02B 5/32; G03H 2001/221

(57) ABSTRACT

There are provided a volume Bragg grating and a method and a system for fabricating it. For instance, there is provided a system that includes a set of spatial light modulators configured to receive a light input. The light input can include a set of input paths where each input path in the set of input paths corresponds to a respective spatial light modulator from the set of spatial light modulators. The system can further include an input light processing module configured to condition an input light beam to output the light input to the set of spatial light modulators. The system can further include an optics module configured to receive a pattern originating from the set of spatial light modulators.

### CROSS REFERENCE TO RELATED APPLICATIONS

This application claims priority from U.S. Provisional Application No. 63/228,587 filed Aug. 2, 2021, the contents of which is hereby incorporated by reference.

### BACKGROUND

Augmented reality (AR) or virtual reality (VR) displays often include optical elements that are used to process light beams by way of diffraction, reflection, and/or transmission. One element that is often used in these displays is a Bragg grating. To facilitate integration with other system components, a volume Bragg grating (VBG) is often used because it can be formed in the bulk of a substrate using micro or nano-fabrication techniques. This approach circumvents the use of free-space discrete gratings which are bulky and not easily integrated with other photonics and electronics components.

VBGs are typically made using a holographic recording. In this method, a photosensitive material is exposed by a light field (recording field) with certain spatial structures. The material's properties (e.g., refractive index) will have corresponding changes that are spatially related to the light field. Using this typical VBG fabrication method, the resulting devices have spatially uniform structures at different locations corresponding to the recording field. In other words, with typical VBGs, the features are periodic, i.e., the pattern of the resulting grating is regular. This inherent limitation in the fabrication method has negative impacts on waveguide performance.

In the state-of-the-art, VBGs with arbitrary structures thus cannot be realized. However, such a structure distribution would confer enhanced optical performance to advanced photonic systems included in modern systems such as AR and VR displays. Therefore, there is a need for VBGs that have arbitrary structure distribution and for methods and systems for fabricating such VBGs.

### SUMMARY

The embodiments featured herein help solve or mitigate the aforementioned issues as well as other issues in the state-of-the of the art. Specifically, they provide methods and systems for fabricating volume Bragg gratings having spatially arbitrary patterns and structures, i.e., non-periodic or non-regular patterns. Such gratings improve waveguide performance and advanced photonic applications such as VR and AR displays.

The teachings featured herein include a novel optical system that combines, by example and not by limitation, hardware such as free-space optical elements, spatial light modulators, and novel software or firmware algorithms realized via application-specific processors. The novel system has the capability of fabricating VBGs with arbitrary structure distribution. The VBGs resulting from this novel fabrication method and system are also novel in that they exhibit spatial variance and feature distribution heretofore unrealizable with current fabrication techniques such as holographic recording. Several example embodiments are briefly described below.

One embodiment may be a system for fabricating a VBG. The system can include a set of spatial light modulators configured to receive a light input. The light input can include a set of input paths where each input path in the set of input paths corresponds to a respective spatial light modulator from the set of spatial light modulators. The system can further include an input light processing module configured to condition an input light beam to output the light input to the set of spatial light modulators. The system can further include an optics module configured to receive a pattern originating from the set of spatial light modulators.

Another exemplary embodiment may be a system that includes a processor and a memory. The memory can include a set of instructions, which when executed by the processor cause the processor to perform operations including generating a series of test patterns on a set of spatial light modulators to initialize a set of system parameters. The generating step can include receiving an input interference pattern. Furthermore, based on the input interference pattern and on the set of system parameters, the operations can further include generating an output interference pattern corresponding to the VBG.

Another exemplary embodiment includes a method for fabricating a VBG using one or more aspects of either one of the above-mentioned systems. The exemplary method can include generating an interference pattern corresponding to the VBG, the generating including. The method can further include receiving a light input at set of spatial light modulators, the light input including a set of input paths wherein each input path in the set of input paths corresponding to a respective spatial light modulator from the set of spatial light modulators. The method can further include conditioning an input light beam to output the light input to the set of spatial light modulator. Furthermore, the method can include receiving, at an optics module, a pattern originating from the set of spatial light modulators where the pattern corresponds to the VBG.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a block diagram of an example AR system in accordance with embodiments of the present disclosure.

FIG. 2 illustrates a detailed block diagram of a waveguide display assembly depicted in FIG. 1.

FIG. 3 illustrates a system for fabricating a VBG according to the embodiments.

FIG. 4. illustrates arbitrary grating patterns achievable with the system shown in FIG. 3.

FIG. 5 illustrates the achievable contrast based on two flat beams in a first sample use case of the system depicted in FIG. 3.

FIG. 6 illustrates the amplitude modulated interference fidelity or field strength in a second sample use case of the system depicted in FIG. 3.

FIG. 7 illustrates the fringe orientation in a third sample use case of the system depicted in FIG. 3.

FIG. 8 illustrates the local distortion in a fourth sample use case of the system depicted in FIG. 3.

FIG. 9 illustrates global distortion in a fifth sample use case of the system depicted in FIG. 3.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

Generally, the embodiments featured herein relate to methods, systems, application-specific processors, software, firmware, hardware, or combinations thereof. These embodiments may be configured in part or in whole to allow the fabrication of novel VBGs having spatial variance heretofore unachievable in the state-of-the-art. In the following paragraphs, we describe some of these exemplary embodiments in broad yet enabling terms.

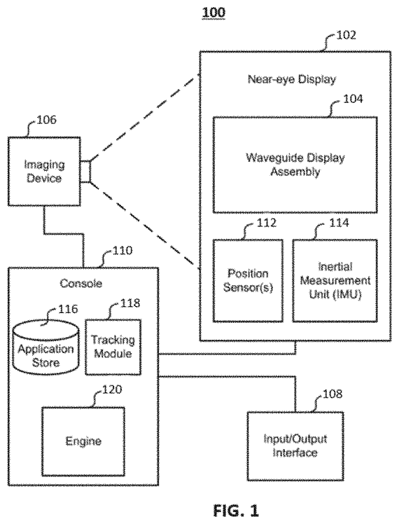

FIG. 1 is a simplified block diagram of an example AR or VR system 100. System 100 includes near-eye display 102, including waveguide display assembly 104. An imaging device 106, and an input/output (I/O) interface 108 that are each coupled to a console 110.

The near-eye display 102 may be a display that presents media to a user. Examples of media presented by near-eye display 102 may include one or more images, video, and/or audio. In some embodiments, audio may be presented via an external device (e.g., speakers and/or headphones) that may receive audio information from near-eye display 102 and/or console 110 and present audio data based on the audio information to a user. In some embodiments, the near-eye display 102 may act as an artificial reality eyewear glass. For example, in some embodiments, the near-eye display 102 may augment views of a physical, real-world environment, with computer-generated elements (e.g., images, video, sound, etc.).

The near-eye display 102 may include the waveguide display assembly 104, one or more position sensors 112, and/or an inertial measurement unit (IMU) 114. The IMU 114 may include an electronic device that can generate fast calibration data indicating an estimated position of near-eye display 102 relative to an initial position of near-eye display 100 based on measurement signals received from the one or more position sensors 112.

The imaging device 106 may generate slow calibration data in accordance with calibration parameters received from the console 110. The imaging device 106 may include one or more cameras and/or one or more video cameras.

The IO interface 108 may be a device that allows a user to send action requests to the console 110. An action request may be a request to perform a particular action. For example, an action request may be to start or end an application or to perform a particular action within the application.

The console 110 may provide media to the near-eye display 100 for presentation to the user in accordance with information received from one or more of: the imaging device 106, the near-eye display 102, and the IO interface 108. In the example shown in FIG. 1, the console 110 may include an application store 116, a tracking module 118, and an engine 120.

The application store 116 may store one or more applications for execution by the console 110. An application may include a group of instructions that, when executed by a processor, may generate content for presentation to the user. Examples of applications may include gaming applications, conferencing applications, video playback application, or other suitable applications.

The tracking module 118 may calibrate the system 100 using one or more calibration parameters and may adjust one or more calibration parameters to reduce error in determination of the position of the near-eye display 100. The tracking module 118 may track movements of the near-eye display 102 using slow calibration information from imaging device 106. Tracking module 118 may also determine positions of a reference point of near-eye display 102 using position information from the fast calibration information.

The engine 120 may execute applications within the system 100 and receives position information, acceleration information, velocity information, and/or predicted future positions of the near-eye display 102 from the tracking module 118. In some embodiments, information received by the engine 120 may be used for producing a signal (e.g., display instructions) to the waveguide display assembly 104. The signal may determine a type of content to present to the user.

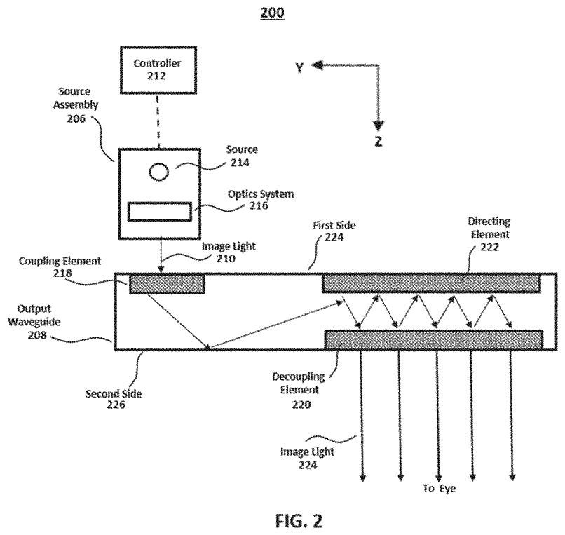

FIG. 2 is a cross-sectional view 200 of the waveguide display assembly 104 from FIG. 1. The waveguide display assembly 104 may include source assembly 206 and output waveguide 208. The source assembly 206 may generate image light 210 (i.e., display light) in accordance with scanning instructions from a controller 212. The source assembly 206 may include a source 214 and an optics system on 216. The source 214 may include a light source that generates coherent or partially coherent light. The source 214 may include, for example, a laser diode, a vertical cavity surface emitting laser, and/or a light emitting diode.

The optics system 216 may include one or more optical components that can condition the light from the source 214. Conditioning light from the source 214 may include, for example, expanding, collimating, and/or adjusting orientation in accordance with instructions from the controller 212. The one or more optical components may include one or more lenses, liquid lenses, mirrors, apertures, and/or gratings. Light emitted from the optics system 216 (and also source assembly 206) may be referred to as the image light 210 or display light.

The output waveguide 208 may receive the image light 210 from source assembly 206. A coupling element 218 may couple the image light 210 from the source assembly 206 into the output waveguide 208. In embodiments where the coupling element 218 includes a diffraction grating, the diffraction grating may be configured such that total internal reflection may occur within the output waveguide 208, and thus image light 210 coupled into the output waveguide 208 may propagate internally within the output waveguide 208 (e.g., by total internal reflection) toward a decoupling element 220.

A directing element 222 may redirect the image light 210 toward the directing element 222 for coupling at least a portion of the image light out of output waveguide 208. In embodiments where the directing element 222 is a diffraction grating, the diffraction grating may be configured to cause incident image light 210 to exit output waveguide 208 at angle(s) of inclination relative to a surface of the directing element 222. In some embodiments, the directing element 222 and/or the decoupling element 220 may be structurally similar to, and may switch their roles for different portions, of the image light 210.

Expanded image light 224 exiting of the output waveguide 208 may be expanded along one or more dimensions (e.g., elongated along the x-dimension). In some embodiments, the waveguide display 204 may include a plurality of source assemblies 206 and a plurality of output waveguides 208. Each of the source assemblies 206 may emit a monochromatic image light corresponding to a primary color (e.g., red, green, or blue). Each of the output waveguides 208 may be stacked together to output an expanded image light 224 that may be multi-colored.

In some implementations, the output waveguide 210 may include a slanted surface between first side 224 and second side 226 for coupling the image light 210 into the output waveguide 208. In some implementations, the slanted surface may be coated with a reflective coating to reflect light towards the directing element 222. In some implementations, the angle of the slanted surface may be configured such that image light 210 may be reflected by the slanted surface due to total internal reflection. In some implementations, the directing element 222 may not be used, and light may be guided within the output waveguide 208 by total internal reflection. In some implementations, decoupling the elements 220 may be located near the first side 224.

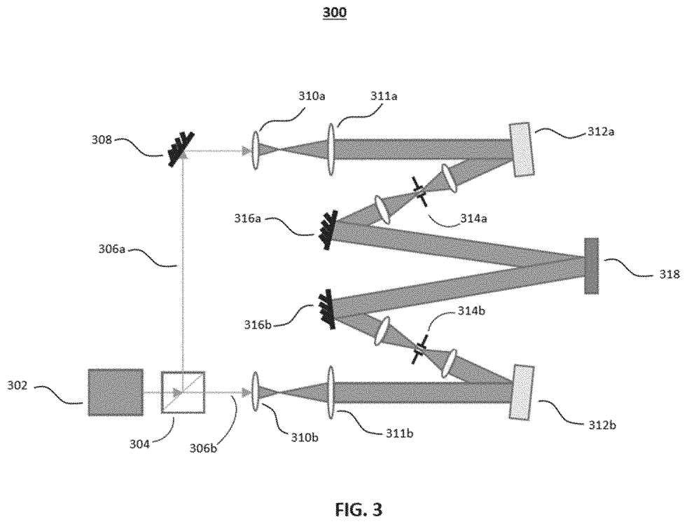

In the design and operation of AR or VR systems like the ones described in reference to FIGS. 1 and 2, a Bragg grating is often used because to achieve one or more of the optical functions of the system. More particularly, a VBG may be used to facilitate integration and yield superior performance than other types of Bragg gratings fabricated using typical thin-film stack methods. Specifically, the VBG is advantageous because it can be formed in the bulk of a substrate using micro or nano-fabrication techniques. In other words, the present approach circumvents the use of free-space discrete gratings which are bulky and not easily integrated with other photonics and electronics components. Novel methods of implementing a VBG for integration in a system like the system 100, and performance measures thereof, are described in reference to FIGS. 3-9 of the present disclosure.

FIG. 3 illustrates a system 300 that implements a VBG according to several aspects of the present disclosure. More specifically, the system 300 provides VBG volume brag grating exposure using two beam interference. By way of example, the system 300 includes a 480 nanometer (nm) wavelength pattern generator 302, although lasers other wavelengths could be used and would be within the spirit and scope of the embodiments. In the system 300, the pattern generator 302 produces a beam 303 that is split by a beam splitter (BS) 304.

The BS 304 splits the beam 303 into along two paths to form beams 306a and 306b. The beam 306a is reflected by mirror 308, such that the beams 306a and 306b are expanded and collimated by two lenses. For example, the beam 306a is expanded and collimated by lens 310a and 311a, respectively. The beam 306b is expanded and collimated by lens 310b and 311b, respectively.

The two beams hit spatial light modulators (SLMs) 312a and 312b, respectively. In the embodiments, the SLMs 312a and 312b are used to achieve the arbitrary structure distribution in VBG fabrication noted above. Each of the SLMs 312a and 312b is a 2D pixel array that enables each pixel to achieve independent optical phase modulation for coherent light. In the system 300, the beams are spatially filtered with pinholes 314a and 314b.

By way of example only, and not limitation, the pinholes 314a and 314b are 100 micrometers (μm) and 200 μm, respectively. However, pinholes of other sizes (e.g., 50 μm, 300 μm, etc.) would be suitable and within the spirit and scope of the embodiments. After spatial filtering, the two beams are reflected by respective mirrors 316a and 316b, reflecting the two beams onto a block sample 318. At a calibration stage of the system 300, the block sample 318 may be replaced by a CMOS sensor array detector to determine patterning quality of the beams.

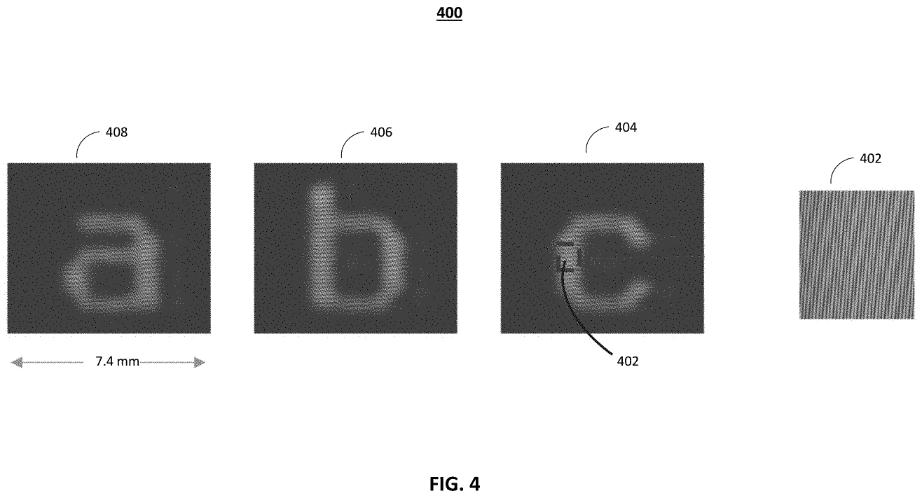

FIG. 4. illustrates arbitrary grating patterns 400 achievable in the system 300 depicted in FIG. 3. The patterns 400 can have arbitrary spatial distribution, with arbitrary periodic fringes within the patterns. Pattern 400 shows fringes 402 created by the two-beam interference of the system 300. The fringes 402 can be used to create arbitrary envelopes, or shapes such as 404, 406, and 408. The fringes 402, shown within the shape 404, are structures that combine to form the shapes 404, 406, and 408.

For example, the shape 404 is formed by a plurality of the fringes 402. More specifically, the fringe 402 may form the grating inside the corresponding photosensitive material. The shape 408 shows that its size is on the order of about 7.4 millimeters (mms), although many other image sizes would be suitable and within the spirit and scope of the embodiments.

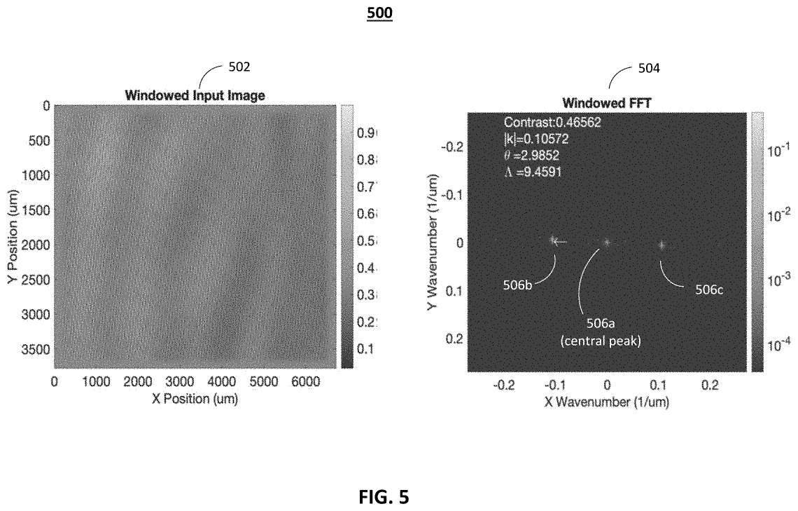

FIG. 5 illustrates a sample use case 500 depicting the achievable fringe contrast based on two flat beams produced by the system 300 of FIG. 3. By way of background, the fringe contrast may be determined as a function of the achievable intensity of the system 300. One approach of defining fringe contrast is expressed in expression (a) below, where (I) equals intensity. In the sample use case 500, the fringe contrast is desirably greater than around (0.7).

Fringe Contrast=(Iₘₐₓ−Iₘᵢₙ)/(Iₘₐₓ+Iₘᵢₙ) (a)

The expression (a) above is merely one approach to determining fringe contrast that was adopted during laboratory analyses. Many other approaches, however, can be used to determine or define fringe contrast. Exemplary metrics, and desirable characterizations applicable to the sample use case 500 are shown in Table 1 below:

TABLE 1

| | |
|---|---|
| Fringe Contrast | >0.7 |
| Amplitude Modulated Interference Fidelity | >1:0.1 |
| (Bright-bright fringe vs. dark-dark fringe) | |
| Local Wavefront Distortion (within 5 mm) | curvature <3e−4 radian |
| Global Wavefront Distortion (within 2 cm) | curvature <3e−4 radian |
| Incident Angle Dependent Aberration | curvature <3e−4 radian |
| Final Pattern Relative Position | shift <500 μm |
| Tiny Feature (<1 mm) Shape and Wavefront | curvature <3e−4 radian |
| Quantification | |

Referring back to FIG. 5, the sample use case 500 represents examples of reliable techniques for determining the fringe contrast. In FIG. 5, for example, a Tukay (e.g., tapered cosine) window is applied to fringes to remove artifacts due to image edges. Fringes are used for constructing the gratings. This process produces windowed input image 502 (e.g., camera measurement pattern), yielding comparable contrast values to a non-windowed image.

For purposes of illustration, \vec{k}_{G} denotes the wave vector for the interference pattern. A camera, or other imaging device, can be used to measure the gratings. A 2-dimensional (2D) Fast Fourier Transform (FFT) is applied to the windowed image 502 to produce image 504. The image 504 shows three image peaks including a central peak 506a, a left modulation peak 506b, and a right modulation peak 506c. One exemplary approach for determining the contrast is provided in expression be below, where amplitude of the central peak 506c is A(0):

Contrast(\vec{k}_{G})≡[A(k_{G})+A(−k_{G})]/A(0) (b)

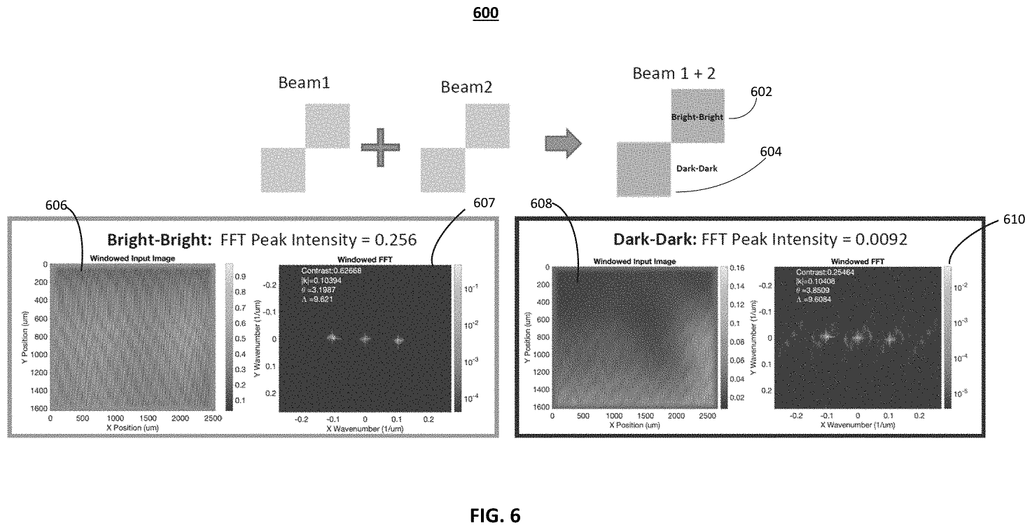

FIG. 6 illustrates the amplitude modulated interference fidelity or field strength in a sample use case 600 of the system 300. Particularly, the sample use case 600 demonstrates a characterization of fidelity. In the embodiments, fidelity is a qualitative measure defining how well target contrast values are achieved. For example, if a target contrast value of zero (0) is desired, or a contrast value of one (1) is desired, fidelity is a measure of how close the actual contrast value compares to zero (0) or one (1).

Bright-bright light from the two beams, at region 602, produces such shapes that interference only happens at a location where the two beams are desired. The two beams are created as a function of the beam-1 shape and the beam-2 shape. Interference only occurs at the top right region 602 of the bright-bright light and a lower left region 604. Bright-bright (e.g., the region 602) denotes the presence of light and dark-dark (e.g., the region 604) denotes an absence of light.

A camera can then be used to measure different locations. For example, the camera can be placed at the bright-bright region 602, a 2D FFT may be applied to input image 606 to produce windowed FFT image 607, and the FFT peak intensity is measured. By way of example, the bright-bright FFT peak intensity of the image 607 is measured to be 0.256. The camera may then be placed at the dark-dark region 604, a 2D FFT is applied to the input image 608 (e.g., fringes) to produce windowed FFT image 610, and the FFT peak intensity is measured. By way of example, the dark-dark FFT peak intensity of the image 610 is measured to be 0.0092. In this manner, the FFT peak intensity ratio may be obtained from expression (c) below.

FFT Peak Intensity Ratio 0.256/0.0092→28:1 (c)

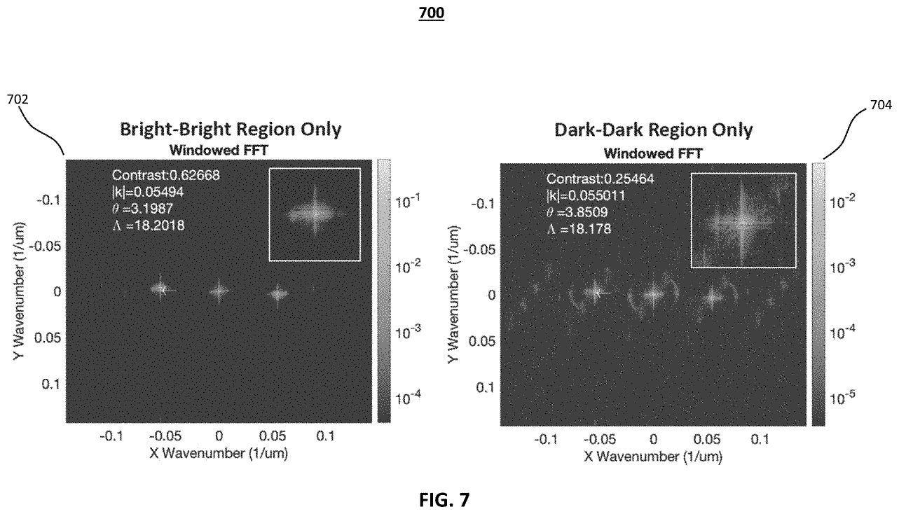

FIG. 7 illustrates an orientation of fringes in a sample use case 700 of the system 300. More specifically, the sample use case 700 measures an amount that the FFT peak shifts across different locations of the beam, such as bright-bright region 702 and dark-dark region 704. In the embodiments, the term FFT peak shift quantifies how much tilt the beamwidth possesses or measures the Δk_{G} across the regions 702 and 704, or other spatial locations. In FIG. 7, (θ) is the angle of the interference pattern K-vector k_{G} in degrees. Ideally, |\vec{Δk}_{G}|<0.0007 and Δ\hat{k}<0.95° as expected from full width half maximum (FWHM) of the peak. Ideally, the contrast>2× higher in the bright-bright region 702.

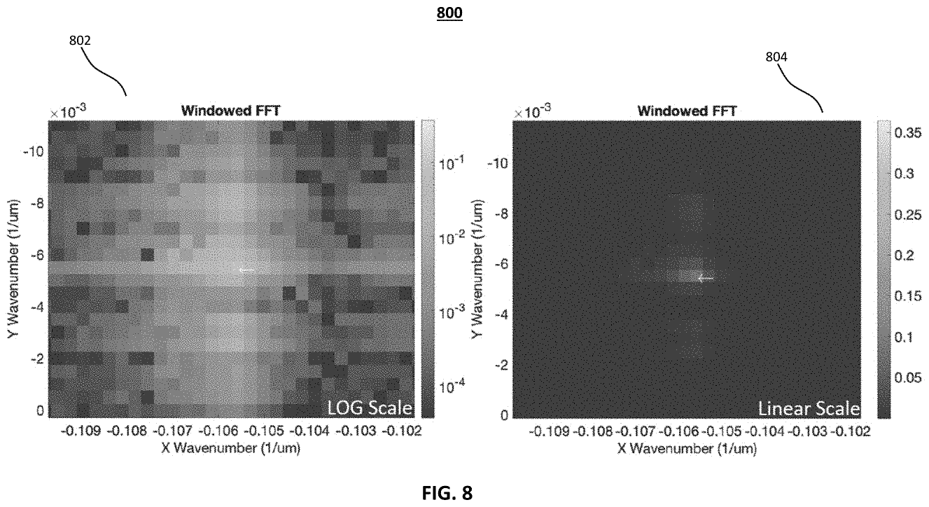

FIG. 8 illustrates local distortion for a sample use case 800 of the system 300. Specifically, FIG. 8 is an illustration of an amplified image 802 of the bright-bright region 702 of FIG. 7. The amplified image 802 (log scale), along with an image 804 (linear scale) of a specific peak, analyzes the distribution, or spreading, of the peak. In practice, the image 802 is a characterization of spreading. In the sample use case 800, such spreading indicates the wavefront, associated with the beam, is torsional.

That is, if the wavefront is perfectly flat, after application of the FFT the resulting image will likely resemble a small, concentrated dot. However, if the wavefront is not perfectly flat (e.g., includes an amount of curvature or random distortion) then after application of the FFT, spreading may be observed. This spreading, measured in terms of FWHM, facilitates a closer analysis of local wavefront distortion. In the sample use case 800, the following example conditions, depicted in Table 2, are ideal in some embodiments:

TABLE 2
Focus on distribution of wavevectors \vec{Δk}_{G} at interference peak
Shape of interference peaks a bit distorted: larger side lobes along Y-
direction
FWHM of peak is |Δ\vec{k}_{G}|~0.0007 1/um (This may be digital limit set
by # of pixels)
Compare this to 460 nm laser wavevector kᵢₙ = 13.09 1/um
|Δ\vec{k}_{G}|~0.0007 → associated variation in in-plane direction: Δ\hat{k}_{G} ~0.95°
|Δ\vec{k}_{G}|~0.0007 → local wavefront distortion of incident beam: Δ\hat{k}ᵢₙ~6 *
10⁻⁵ rad

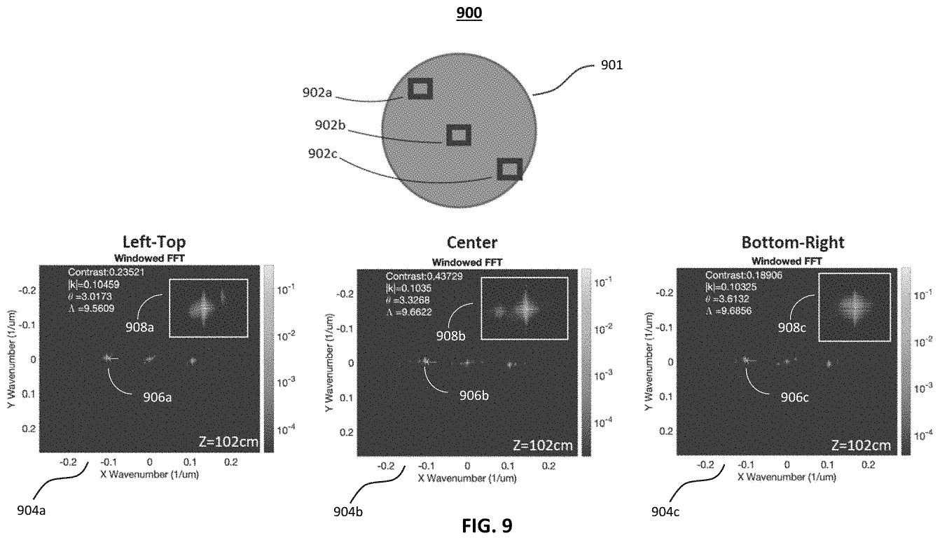

FIG. 9 illustrates global distortion in a sample use case 900 of the system 300. Specifically, FIG. 9. shows a cross-section 901 of a large beam (e.g., about 2 centimeters) and characterizes, spatially, the degree of wavefront flattening in the large beam. To produce the beam cross-section 901, the camera was placed at positions 902a, 902b, and 902c in the path of the beam. Photos were taken at each of the positions 902a, 902b, and 902c. An FFT was applied to each of the resulting images to produce windowed FFT images 904a, 904b, and 904c, respectively.

An FFT peak is shown for each of the images 904a, 904b, and 904c. For example, each of the FFT peaks 906a, 906b, and 906c correspond to a respective one of the images 904a, 904b, and 904c. Amplified images 908a, 908b, and 908c show the respective peaks 906a, 906b, and 906c in greater detail. Subsequently, the camera was spatially repositioned to different parts of the beam, within the sample use case 900, and additional FFT's were applied. However, the corresponding FFT peaks remained substantially in the same location within the Fourier space. Table 3 below applies to the sample use case 900.

TABLE 3
Change in location of FFT peaks at different locations on the beam
indicate variation in wavefront of the two beams across the profile of
beam.
Magnitude variation across beam: |Δ\vec{k}_{G}|~0.0014 1/um
Again, |Δ\vec{k}_{G}|~0.0014 1/um → Δ\hat{k}ᵢₙ~1 * 10⁻⁴ rad
Side lobes larger than center peak. Quoted contrast |k| theta values are for
the weaker center peak.

The sample use case 900 demonstrates that across the entire beam, the wavefront is going towards the same angle or direction. That is, distortion does not vary significantly at different beam locations.

One embodiment of the present disclosure may be a system for fabricating a VBG. The system can include a set of spatial light modulators configured to receive a light input. The light input can include a set of input paths where each input path in the set of input paths corresponds to a respective spatial light modulator from the set of spatial light modulators. The system can further include an input light processing module configured to condition an input light beam to output the light input to the set of spatial light modulators. The system can further include an optics module configured to receive a pattern originating from the set of spatial light modulators.

The exemplary system can include a light source configured to output the input light beam in an input port of the input light processing module, and the input light beam may be a laser. The input light processing module can be further configured to spatially filter the input light beam, expand the input light beam, collimate the input light beam, and/or split the light beam into multiple beams, which may be flat.

The system can further include, in the optics module, disposed in one or more stages, at least one lens and/or least one pinhole. These optical elements may be disposed in one or more stages. One of skill in the art will readily mentioned, other optical elements such as neutral density filters, mirrors, prisms, etc. can also be used without departing from the teaching of the present disclosure. The purpose of these elements impart functionality to the optics module for the purpose of projecting the pattern onto a photosensitive material. This material, once exposed to the pattern and developed, according to nano or microfabrication procedures, may serve as template for transferring the pattern onto an underlying substrate to make the VBG.

Another exemplary embodiment may be a system that includes a processor and a memory. The memory can include a set of instructions, which when executed by the processor cause the processor to perform operations including generating a series of test patterns on a set of spatial light modulators to initialize a set of system parameters. The generating step can include receiving an input interference pattern. Furthermore, based on the input interference pattern and on the set of system parameters, the operations can further include generating an output interference pattern corresponding to the VBG.

This exemplary system can further include an input light processing module configured to condition an input light beam to output a light input to the set of spatial light modulators, and it can also include an optics module configured to (i) receive the output interference pattern from the set of spatial light modulators and to (ii) project the output interference pattern on a photosensitive material. The system can further include a camera positioned at an output port of the system to sense the series of test patterns.

Another exemplary embodiment includes a method for fabricating a VBG using one or more aspects of either one of the above-mentioned systems. The exemplary method can include generating an interference pattern corresponding to the VBG, the generating including. The method can further include receiving a light input at set of spatial light modulators, the light input including a set of input paths wherein each input path in the set of input paths corresponding to a respective spatial light modulator from the set of spatial light modulators. The method can further include conditioning an input light beam to output the light input to the set of spatial light modulator. Furthermore, the method can include receiving, at an optics module, a pattern originating from the set of spatial light modulators where the pattern corresponds to the VBG. The method can further include projecting the pattern on a photosensitive material.

The method can further include generating a series of test patterns on the set of spatial light modulators to initialize a set of system parameters. This step can serve as a calibration routine for subsequent fabrication steps, and it may include using a camera to evaluate, visualize, and/or record the set of system parameters and/or the test patterns. In the method, the light beam can correspond to an input interference pattern.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A system for fabricating a volume Bragg grating, the system comprising:
a set of spatial light modulators configured to receive a light input, the light input including a set of input paths wherein each input path in the set of input paths corresponds to a respective spatial light modulator from the set of spatial light modulators;
an input light processing module configured to condition an input light beam to output the light input to the set of spatial light modulators; and
an optics module configured to receive a pattern originating from the set of spatial light modulators.

2. The system of claim 1, further comprising a light source configured to output the input light beam in an input port of the input light processing module.

3. The system of claim 2, wherein the input light beam is a laser.

4. The system of claim 1, wherein the input light processing module is further configured to spatially filter the input light beam.

5. The system of claim 1, wherein the input light processing module is further configured to expand the input light beam.

6. The system of claim 1, wherein the input light processing module is further configured to collimate the input light beam.

7. The system of claim 1, wherein the input light processing module is further configured to split the input light beam.

8. The system of claim 7, wherein the input light processing module is further configured to split the input light beam into a set flat beams to form the light input to the set of spatial modulators.

9. The system of claim 1, wherein the optics module includes, disposed in one or more stages, at least one of a lens and a pinhole.

10. The system of claim 1, wherein the optics module is further configured to project the pattern on a photosensitive material.

11. A system for fabricating a volume Bragg grating (VBG), the system comprising:
a processor;
a memory including instructions, which when executed by the processor cause the processor to perform operations including:
generating a series of test patterns on a set of spatial light modulators to initialize a set of system parameters;
receiving an input interference pattern; and
generating, based on the input interference pattern and on the set of system parameters, an output interference pattern corresponding to the VBG.

12. The system of claim 12, further comprising:
an input light processing module configured to condition an input light beam to output a light input to the set of spatial light modulators; and
an optics module configured to (i) receive the output interference pattern from the set of spatial light modulators and to (ii) project the output interference pattern on a photosensitive material.

13. The system of claim 12, further comprising a camera positioned at an output port of the system, the camera being configured to sense the series of test patterns.

14. A method of fabricating a volume Bragg grating (VBG) using a system, the method comprising:
generating an interference pattern corresponding to the VBG, the generating including:
receiving a light input at set of spatial light modulators, the light input including a set of input paths wherein each input path in the set of input paths corresponding to a respective spatial light modulator from the set of spatial light modulators;
conditioning an input light beam to output the light input to the set of spatial light modulators; and
receiving at an optics module a pattern originating from the set of spatial light modulators, the pattern corresponding to the VBG.

15. The method of claim 14, further comprising generating a series of test patterns on the set of spatial light modulators to initialize a set of system parameters.

16. The method of claim 15, wherein the input light beam corresponds to an input interference pattern.

17. The method of claim 15, wherein the pattern corresponding is an output interference pattern.

18. The method of claim 15, further comprising calibrating the system, the calibrating including generating the set of system parameters.

19. The method of claim 18, further comprising using a camera to generate the set of system parameters.

20. The method of claim 14, further comprising projecting the pattern on a photosensitive material.
